(19) United States
(12) Patent Application Publication
(10) Pub. No.: US 2007/0147324 A1
(43) Pub. Date: Jun. 28, 2007

(54) System and method for improved WiFi/WiMax retail installation management

(76) Inventor: Faith McGary, Bethlehem, PA (US)

Correspondence Address: SOFER & HAROUN LLP., 317 MADISON AVENUE, SUITE 910, NEW YORK, NY, 10017, US

(21) Appl. No.: 11/606,387

(22) Filed: Nov. 29, 2006

Related U.S. Application Data
(60) Provisional application No. 60/740,687, filed on Nov. 29, 2005.

(51) Int. Cl. H04Q 7/24

(52) U.S. Cl. 370/338; 370/395.52

(57) ABSTRACT

A system for managing wireless internet access. The system includes an interface for receiving incoming requests for wireless internet access from a plurality of subscribers. The subscribers submit requests from a wireless access provider having a plurality of geographic locations at least one request coming from one location and at least a second request coming from a different location. An authentication module authenticates account information from the subscriber. A session manager monitors each of the wireless internet access sessions of each of the subscribers. A data collection and storage module stores said session information. A mediation module supplies usage reports to the wireless access provider based on the session information from each of the subscribers at each of the plurality of locations.

### RELATED APPLICATION

The present invention is related to and claims the benefit of priority from U.S. Provisional Patent Application No. 60/740,687, filed on Nov. 29, 2006, the entirety of which is incorporated herein by reference.

### FIELD OF THE INVENTION

The present invention relates to WiFi/WiMax wireless internet access. More particularly, the present invention is related to management of WiFi/WiMax installations. BACKGROUND

Wireless internet access is a method for providing internet access and other network capabilities to a mobile/wireless client device such as laptops, personal digital assistants (PDAs) etc. . . . Wireless internet access is typically provided by a wireless router, commonly referred to as a WiFi (Wireless Fidelity) or WiMax (Worldwide Interoperability for Microwave Access) router.

Apart from home use, the supplying of wireless internet access to customers at retail locations and other commercial and non-commercial institutions is becoming more common. In many instances, the wireless access is being offered in larger commercial chains such as Starbucks™ and McDonalds™. In the case of commercial chains offering wireless internet access, wireless internet providers are typically partnered with to handle the access.

For example, FIG. 1 shows a prior art arrangement where a first retail location 12A provides wireless internet access (hot spot) to a plurality of users 10 via a service provider 14 and a second retail location 12B also provides wireless internet access to a plurality users 10 via service provider 14.

In another example, enterprises and universities are now widely deploying wireless local area networks (LANs) based on the IEEE 802.11 (and 802.16) standards. Users with client devices such as laptops and PDAs use an 802.11 network interface card that provides them wireless access to the Internet. In addition to replacing traditional Ethernet-based local area networks, these wireless LANs are now also being deployed in other novel settings. Of special interest is the increasing deployment of these 802.11 based networks in public spaces and hot spots such as, e.g., airports, convention centers, hotels, and even local coffee shops. These hotspots can provide Wi-FI/Wi-MAX service at fast speeds with coupled LAN access.

These Wi-FI/Wi-MAX service providers (i.e., service providers who own direct relationships with end users), and particularly the commercial providers, are constantly challenged to excel at meeting the needs of their end users. These needs include, for example: providing service coverage across key venues; a simple, reliable and high-quality end user experience; enterprise-quality security in a public environment; access to a suite of local and global applications; enterprise-level management of end user usage and costs; and affordable pricing plans for enterprise and individual users.

However, existing arrangements have a number of drawbacks concerning session management, authentication log-on/log-off services, record keeping and billing. For example, it is difficult for a large geographically divers access provider to manage usage and billing data, particularly when it employs multiple service providers for different geographic locations. Such drawbacks, in addition to being problems in and of themselves, also leave a large amount of tracking data either uncollected or otherwise underutilized which would be of great value to the retail wireless access providers and to the wireless service providers.

### OBJECTS AND SUMMARY

The present invention looks to overcome the drawbacks associated with the prior art and to provide a system and method for providing uniform session management, authentication log-on/log-off services, record keeping and billing for wireless internet access. Another object of the present invention is to provide detailed record keeping of wireless internet access sessions to assist in tracking of the users' actions and habits for reporting to the wireless providers. Yet another object of the present invention is to provide such services in manner linked with traditional enhanced directory assistance (typically employed in the telephone environment) such that various directory assistance services may be handled via the user's wireless connection.

The system and method of the present invention includes receiving at a gateway, coupled to the service provider network, a request for authenticating a subscriber desiring access to either the internet directly or the internet via a local area network. The request contains the subscriber's credentials. They are authenticated based on their credentials and information relating to the subscriber previously stored in a subscriber database.

The local area network or (LAN) access (and accompanying WiFi internet access) is authorized to grant access to the subscriber when the subscriber is authenticated. A link is established between the system gateway and a client program operating on the subscriber's terminal. Session information is collected either through system gateway itself or through the link between the system gateway and the client program.

The gateway of the present invention may provide, among other features: (1) advanced service plan support allowing creation and enforcement of complex service plans around several parameters such as locations, connections, duration, and volume; (2) prepay support for authentication, monitoring, and management of prepaid sessions; (3) aggregation and mediation of multi-session records for complex service plans (ie. total time sessions rather than per log-on sessions), including prepaid and postpaid sessions; (4) enhanced security through end-to-end credential encryption; (5) interface to external subscriber databases for flexible access to subscriber information; (6) interface to export records to external systems for easy reporting and data manipulation by operators; and (7) installation macros to simplify configuration of roaming relationships.

The service manager client program, if utilized to log-on for wireless internet access via a LAN using LAN access cards, may provide among other services: (1) “Dashboard” architecture, providing integrated client skins; (2) customizable profiles, allowing service provider, Wi-FI/Wi-MAX operator, and user customization of network, security, and application settings; (3) tethered phone support; (4) driver management, allowing management of up to-date versions of Wi-FI/Wi-MAX drivers; (5) conflicting application management, allowing detection and management of conflicting applications on end-user terminals; and (6) authentication enhancements to support multiple roaming network configurations.

To this end, the present invention is directed to a system for managing wireless internet access. The system includes an interface for receiving incoming requests for wireless internet access from a plurality of subscribers. The subscribers submit requests from a wireless access provider having a plurality of geographic locations at least one request coming from one location and at least a second request coming from a different location.

An authentication module authenticates account information from the subscriber. A session manager monitors each of the wireless internet access sessions of each of the subscribers. A data collection and storage module stores said session information. A mediation module supplies usage reports to the wireless access provider based on the session information from each of the subscribers at each of the plurality of locations.

### BRIEF DESCRIPTION OF THE DRAWINGS

The present invention can be best understood through the following description and accompanying drawings, wherein:

FIG. 1 illustrates a prior art wireless internet access arrangement for a retail wireless internet access provider;

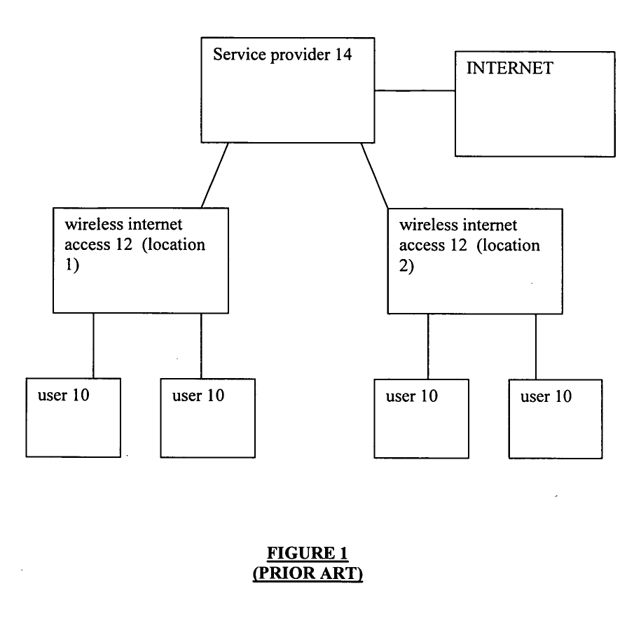

FIG. 2 illustrates a system gateway for managing wireless internet access, in accordance with one embodiment of the present invention;

FIG. 3 illustrates a system gateway for managing wireless internet access, in accordance with anther embodiment of the present invention;

FIG. 4 illustrates a system gateway for managing wireless internet access, in accordance with one embodiment of the present invention;

FIG. 5 illustrates a block diagram of the gateway from FIG. 2, in accordance with one embodiment of the present invention;

FIG. 6 illustrates a block diagram of the service manager application from FIG. 4, in accordance with one embodiment of the present invention;

FIG. 7 illustrates a block diagram of the gateway from FIG. 2 coupled to a directory assistance system, in accordance with one embodiment of the present invention;

FIG. 8 is a flow chart depicting the operation of a wireless session conducted via the gateway of either FIG. 2 or 4, in accordance with one embodiment of the present invention; and

FIG. 9 is a flow chart depicting the operation of a wireless session conducted via the gateway of either FIG. 2 or 4, in accordance with another embodiment of the present invention.

### DETAILED DESCRIPTION

The present invention provides a unified access control for wireless internet access provided by various installations such as wireless access providers 12, including but not limited to retail stores or other commercial and non-commercial institutions. For the purposes of illustrating the salient features of the present invention, the present invention is described in conjunction with chain retail stores 12 that provide wireless internet access. However it is understood that the feature described below are equally applicable to any multi-location wireless internet access installations.

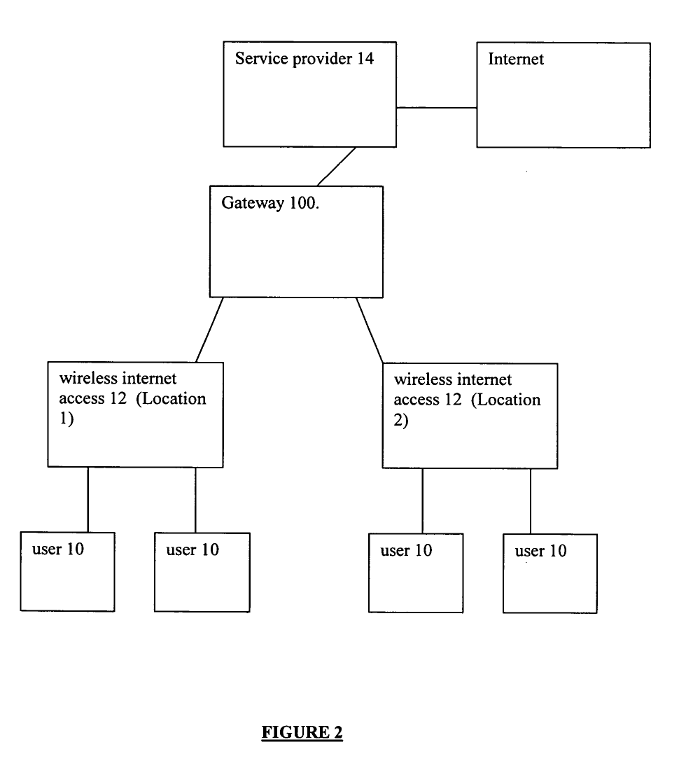

In one embodiment of the present invention illustrated in FIG. 2, a gateway device 100 is situated between wireless access providers 12 (and their associated Wi-Fi/WiMax routers) and service provider 14. As discussed in more detail below, gateway 100 provides all session log-on/log-off, billing and other related session management for wireless internet access through providers 12.

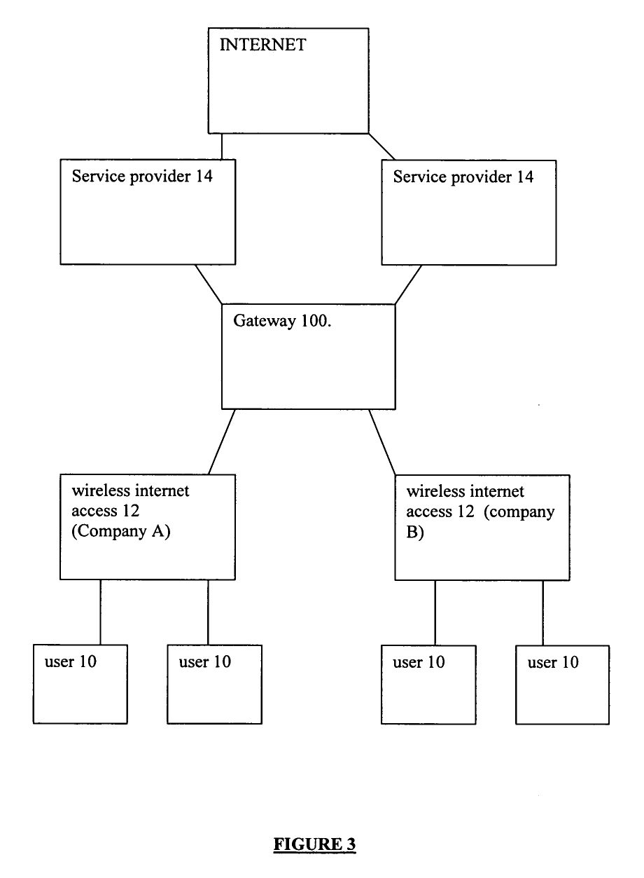

For illustration purposes, FIG. 3 shows a real-world arrangement whereby gateway 100 is shown to manage multiple access providers 12 having multiple locations as well as the accompanying interfaces with multiple service providers 14. For simplicity, the arrangement of FIG. 2 with only one provider 12 (at several locations) and one service provider 14 are used to illustrate the various feature of the present invention.

Returning however to FIG. 2 to illustrate the features of the present invention, it is noted that although gateway 100 is shown as a single element for illustration purposes, it is understood that gateway 100 may represent a cluster of distributed gateways 100, accessible by a single IP address, that are operated in a linked manner, even though geographically distributed. Furthermore, gateway 100 is shown apart from internet/wireless service provider 14. However, gateway 100 (or clusters of gateways 100), may be employed directly as a node within the network of service provider 14.

If gateway 100 is deployed within the network architecture of a service provider 14, it may be deployed in either a GSM (Global System for Mobile Communications)/GPRS (General Packet Radio Services) or a CDMA (Code Division Multiple Access)/1βRTT (CDMA2000-3G mobile) arrangement. In each arrangement gateway 100 of the present invention may be either in an integrated architecture or overlay architecture. In the integrated architecture, gateway 100 is in direct contact with the existing access, billing and core nodes of the service provider 14, augmenting the services provided. In an overlay architecture, gateway 100 may directly takeover certain billing and access operations. As discussed throughout for illustrative purposes, it is assumed that gateway 100 is performing all of the functions independently of service provider 14. However, it is understood that such operations may be integrated directly into some of the existing network architecture of service providers 14.

The multi-site clusters of gateways 100 may be deployed in a number of ways including load distribution mode and back-up mode. In load distribution mode, some clients (wireless access providers 12) point to one cluster as the primary and use a second cluster as a backup, while other access providers 12 point to the other cluster as a primary. This deployment provides geographic load sharing. In back-up mode one cluster of gateways 100 may be used as the primary cluster for all traffic and the second cluster of gateways may be used for backup.

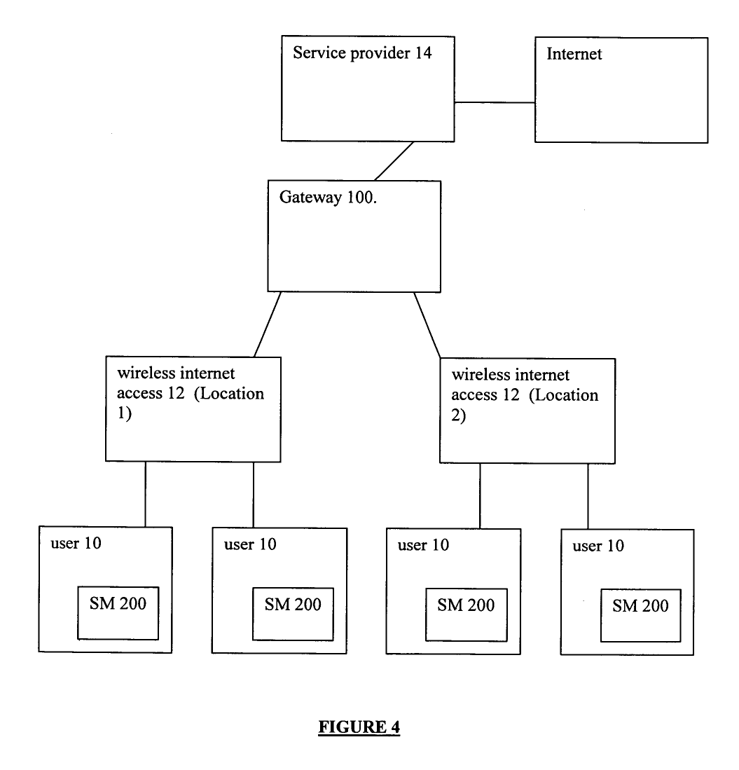

In one embodiment of the present invention, FIG. 4 shows an alternative arrangement, whereby in addition to system gateway 100, a service manager application 200 is operated on the terminal of subscriber 10. As discussed in more detail below, service manager program 200 is typically operated as a plug-in application that is added to the device of subscriber 10 either via its incorporation into the LAN access card used at access provider 12 or communicated directly through a web page supported by access provider 12 or their affiliates.

The following discussion of the operation of the present invention discusses both the operation of gateway 100 as well as service manager application 200. However, it is understood that the present invention may operate solely with gateway 100 as shown in FIG. 2, or alternatively, with both gateway 100 and service manager application 200 as shown in FIG. 4, for additional data transmission, seamless usability, added security and other enhanced features. The following description begins with the operation and features of gateway 100 and then follows with the additional operations that may be maintained with the addition of service manager application 200.

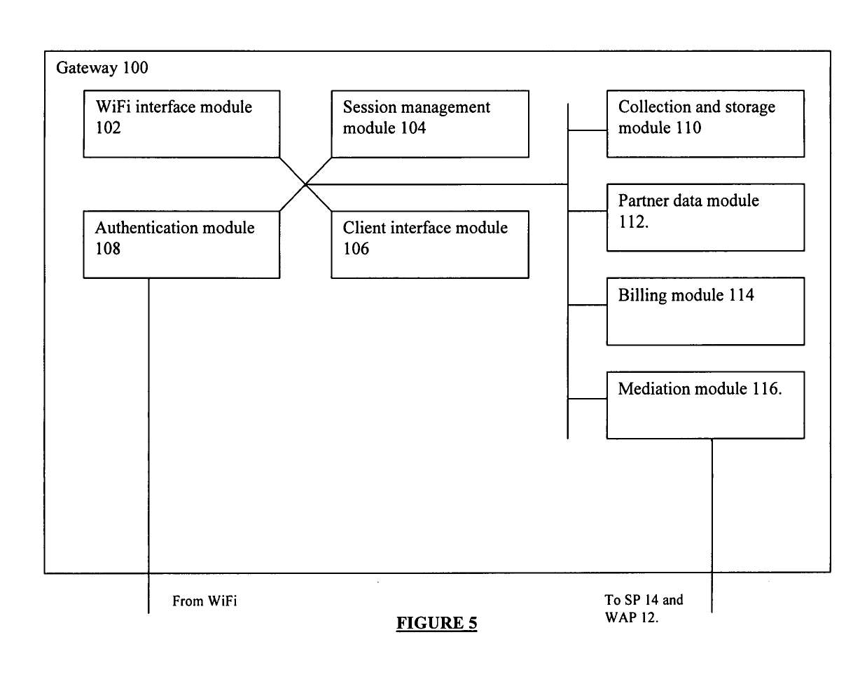

In one embodiment of the present invention, FIG. 5 illustrates the various modules of gateway 100. This list of modules is not exhaustive or limiting of the total number of modules within gateway 100, but is for illustrating the important features thereof.

A WiFi interface module 102 may be implemented to connect with the wireless access providers 12 and their associated WiFi/WiMax routers. It is noted the interface module 102 is typically configured to interface with providers 12 employing RADIUS hot spots. RADIUS (Remote Authentication Dial In User Service) is an authentication, authorization and accounting protocol (AAA) for applications such as network access that works in both local and roaming. It is understood that gateway 100 may also be employed with other standard formats such as DIAMETER protocol.

A session manager module 104 implements the core real-time session management capability in gateway 100. For example, session manager module 104 maintains the real-time state for all the active subscriber 10 sessions, such as authentication state, usage, device from which the session was initiated, IP address, MAC address. Session manager 104 also manage the state for service plans of subscribers 10 that last through multiple sessions and controls prepaid sessions.

An additional feature of session manager 104 is to manage complex “multi-sessions.” These multi-sessions are generated as a result of the common service plans used by various service providers 14 and access providers 12. For instance, a service plan may allow unlimited logins from a single location over certain duration. In this case, multiple sessions may be created, one every time subscriber 10 logs in through gateway 100. However, there is only one ‘billable’ session for all the sessions within this duration. Session manager 104 of gateway 100 has the ability to define, authorize, and enforce such service plans. Such, pre-paid or complex multiple log-on sessions may be monitored to warn subscriber 10 of a low balances, offer the ability to top re-up an account, and support session disconnection. Necessary storage for such management may be handled by collection and storage module 110 and authentication module 108 discussed below.

A client interface module 106 collects additional session records and delivers them to data collection and storage module 110. Additionally, client interface module 106 provides the external interface for subscriber 10 connections that utilize service manager application 200 as opposed to a direct RADIUS connection through WiFi interface 102. As noted above, gateway 100 support direct connections from access points 12 without service manager application 200. In such instances incoming communications would interface directly with interface module 102 in a RADIUS arrangement. However, if using a LAN card or other web-based manner for implementing service manager application 200, then the connection to gateway 100 may be handled directly by client interface module 106 which may augment the real-time record collection.

An authentication module 108 supports the authentication of subscribers 10, including passwords, log-on IDs, and all of the associated protocols used by various wireless providers 12 including all the 802.1x protocols such as MD5, PEAP, MS-CHAP, and EAP SIM.

A collection and storage module 110 manages the collection and storage of session usage data received from both session manager 104 and the client interface 106. Data collection and storage module 110 also maintains the necessary records for to compliment authentication module 108 to properly identify subscribers 10. Collection and storage module 110 may also processes multiple sessions to generate aggregated session records. This data may be utilized by wireless access providers 12 and service providers 14 to generate reports on usage and to audit hotspot performance and activity patterns.

A partner data module 112 maintains a database of wireless access providers 12 and their relevant information such as all of the pertinent information regarding the WiFi/WiMax routers, such as locations, speed, IP addresses, etc. . . . Partner module 112 also includes information regarding the service providers 14 including rate plans, and connectivity arrangements necessary for mediation module 116 to settle accounts with the various partners (wireless access providers 12 and service providers 14).

For example, for large access providers 12 having many geographically diverse locations, it is possible that they utilize different service providers 14 for different geographic reasons. In such situations, it is particularly difficulty to manage the overall usage of all subscribers 10. Furthermore, presents a more complex scenario for settling the billing accounts. This added level of complexity makes it more difficult to audit the services offered by an access provider 12, for value, marketing, and affiliated advertising options. Mediation module 116 discussed in more detail below can utilize data from partner data module 112 to assist an access provider 12 with aggregating all of the necessary billing and usage data.

In prior art arrangements potentially difficult information to capture and manage is the database of home and partner network locations. Partner data module 112 is preferably maintained accurately as it is used to create hotspot location directories of other locations of wireless access providers 12 that subscribers 10 can search through either directly through a link on a web browser, or via service manager application 200, when available. Gateway 100 can incorporate a mechanism for location auto-discovery whereby the partner data module 112 is populated with new locations whenever service manager application 200, employed by a subscriber 10, is accessed at a location, regardless of whether gateway 100 has been pre-configured to be aware of said location. This mechanism creates a self-maintaining partner data module minimizing maintenance and increasing accuracy- and provides a simple mechanism for wireless access providers 12 to inform subscribers 10 of new locations.

A billing module 114 is configured to utilize information from collection and storage module 110 as well as session management module 104 to generate complete billing records for wireless access provider 12, service providers 14 as well as subscribers 10 if applicable.

The mediation module 116 is for interfacing with external modules of both wireless access providers 12 and service providers 14. The information provided may include, among other things, the usage reports generated from data in collection and storage module 110 as well as billing module 112. Data may be formatted into GCDR, TAP3 (data record formats) or other such formats and can be delivered as desired.

As noted above, one of the features of utilizing gateway 100 to manage WiFi/WiMax access is that gateway 100 stores a larger amount of usage data stored in data collection and storage module 110, to be reported to wireless access providers 12 and service providers 14 through mediation module 116.

The following TABLE 1 is an exemplary, though not exhaustive listing of potential information that data collection and storage module 110 may store relating to a session initiated by subscriber 10 at wireless access point 12.

TABLE 1

| | |
|---|---|
| User Realm | Realm (system notation) used to authenticate this user |
| User Id | Subscriber Id (User Name, Phone Number of IMSI) |
| | used to authenticate this user |
| Device Id | Device Id with which the subscriber connected to the |
| | session |
| Start Time | Start time of the session |
| End Time | End time of the session |
| Gateway Id | Id of Gateway |
| Gateway Session | Session Id given to a session by the Gateway |
| Id | |
| Error Code | Error code for the session |
| User Name | User name of the subscriber |
| Phone Number | Phone number of the subscriber |
| IMSI | IMSI (International Mobile Subscriber Identifier) of |
| | the subscriber |
| Pay Plan | Pay plan of the subscriber |
| Service Plan Id | Id of the subscriber's service plan |
| Service Access Id | Access Id of the subscriber's service plan Service Start |
| Time Start | Start time of the subscriber's service plan |
| Service End Time | End time of the subscriber's service plan |
| Service Plan Days | Valid days of the subscriber's service plan |
| Service Location | Location categories of the subscriber's service plan |
| Service Access | Access of the subscriber's service plan |
| NAS Id | Id of the Network Access Server (at access provider |
| | 12) |
| NAS Certificate | Id of the Network Access Server security certificate |
| Id | |
| NAS IP | IP Address of the Network Access Server |
| NAS Session Id | Session Id given by the Network Access Server |
| Location Partner | Location partner (12) providing service at this location |
| Location Id | Id of this location |
| Location Name | Name of this location |
| Location Address | Location address of this location |
| Location TZ | Offset of this location from GMT Location, DST |
| | if Flag Was DST in effect |
| Location | Location category of this location |
| Category | |
| Auth Method | Authentication method used |
| Auth Proxy | Was this authentication proxied? |
| Interims | Number of interim accounting records |
| Bytes In | Bytes transferred in during session |
| Bytes Out | Bytes transferred out during session |
| Packets In | Packets transferred in during session |
| Packets Out | Packets transferred out during session |
| Session Duration | Duration of session |
| Term Cause | Cause of the session termination |
| Client Version | Version of the client software |
| Client SN | Serial number of the client |
| Client IP | IP address of the client |

Such information can be used for various gateway 100 functions, such as real-time tracking of subscriber 10 activity as well as for reports issued by mediation module 116 to service provider 14 of wireless access provider 12, both of which are discussed in more detail below.

In another embodiment of the present invention, service manager application 200 is a software application, plug-in or other such web-based application that is provided to subscriber 10 for use on the accessing device. An exemplary implementation of service manager 200 is a plug-in application that is included on wireless LAN access card that is employed by a subscriber 10 for wireless LAN/internet access. Another implementation of service manager application 200 is for direct download from a web page via gateway 100, where the web page is maintained by access provider 12 or their affiliates.

As noted above, although gateway 100 of the present invention may operate without an accompanying service manager application 200 on a subscriber 10 device, the use of service manager application 200 may provide additional advantages such as improved security, improved information tracking, improved application transfer and improved access provider 12 control over the look and feel of the interface that subscriber 10 uses when at the establishment of access provider 12.

The following information and services, handled through service manager application 200 are discussed, for exemplary purposes, as being imported from a plug-in from a LAN access card or from an access provider 12 managed web page. However, it is understood that each and every application discussed in conjunction with service manager application 200 may be equally employed as simply an application run entirely through a web page managed by access provider 12 or service provider 14 that enables the same services without an actual application being imported on the device of subscriber 10.

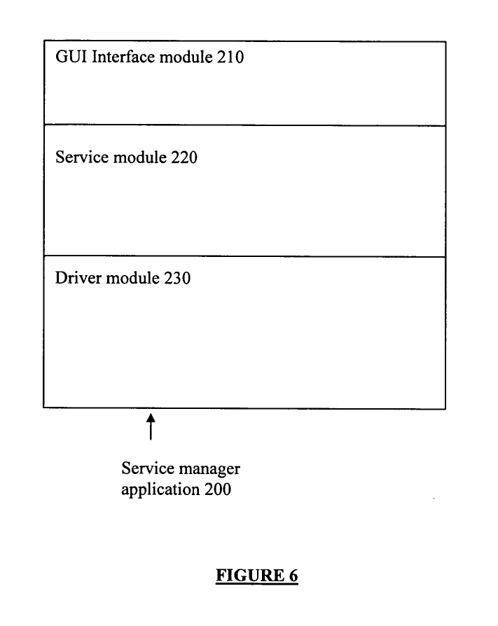

In one embodiment of the present invention, as illustrated in FIG. 6, an exemplary service manager application 200 architecture is shown. Service manager application 200, maintains a GUI (Graphical User Interface) module 210, a service module 220 and a driver module 230. It is important to note that service manager application 200 may be implemented in any number of ways including, but not limited to installation on the device of subscriber 10, implementation on the device of subscriber 10 via an inserted LAN card, or even permanent installation on the device of subscriber 10 as a pre-installation (from manufacturer of the device). Regardless of how service manager application 200 is installed the following is a non-exhaustive exemplary list of functional modules.

GUI module 210 enables subscriber 10 to view and connect to service provider 14 networks via wireless access locations 12, manage connection profiles, search for network locations (other physical locations of wireless access points managed by wireless provider 12), perform automatic software and data updates, and access help files.

GUI module 210 of service manager application 200 may be implemented as a tray icon within the operating system of the device of subscriber 10. GUI module 210 is configured to interact with authentication module 108 and session management module 104 to initiate, maintain, and terminate a wireless session. GUI modules 210 may further be configured to interact with gateway 100 to enable updates, application downloads, and other access provider 12 applications that are supported through gateway 100 as discussed below.

GUI module of service manager 210 can be branded by a customer (wireless provider 12) to a specific look and feel. GUI module 210 may support ‘dynamic skinning,’ or the ability to load a different look and feel at run time. GUI module 210 of service manager 200 is preferably designed around a ‘dashboard’ paradigm, which allows subscriber 10 to use service manager application 200 as an application launch pad, in addition to wireless connection management.

In another embodiment of the present invention, service module 220 forms the communication hub for driver module 230 and GUI module 210. Service module 220 is configured to handle the additional functions, mentioned above such as application updates and other such enhanced features.

For example, service module 220 allows GUI module 210 to authenticate credentials to be exchanged and session information such as bytes in/out to be presented to the subscriber 10 during the session. This allows subscriber 10 to better handle their session and manage time and access fees.

Another enhanced feature managed by service module 220 also handles authentication via 802.1x or HTTP intercept mechanisms, allowing subscriber 10 to seamlessly utilize varying authentication methods from different NAS (Network Access Servers) used at different locations of wireless access provider 12. Such a situation would occur where a subscriber 10 would attempt to log-on at different locations owned/operated by access provider 12 using the same account, where each location may utilize a different router device (having a varied authentication process).

In yet another embodiment, service module 220 includes the necessary information and protocols to manage the wireless internet connection with service provider 14. Such an application may assist in managing SMS services on the wireless link.

Service module 220 may also be configured to communicate with gateway 100 to coordinate a secure communication mechanism between subscriber 10 and gateway 100. This enhanced security link may then be utilized to perform software updates (of service manager 200), location directory updates, collection and delivery of session logs, Wi-FI/Wi-MAX session information, etc. This may be used to provide end-to-end encryption of subscriber 10 credentials. This is especially useful when subscriber 10 is in a roaming wireless provider 14 network and the service provider 14 of subscriber 10 being used through access provider 12 does not wish to expose the identity of its users to roaming networks. To support credential encryption, service manager application 200 and gateway 100 share an encryption key, in a typical encryption such as DES.

Additionally, data supplied through this secure connection, such as location databases and profiles of access providers 12, may be stored to the subscriber 10 device from improved access to access provider applications, and further to allow certain functions, such as searching for wireless access provider 12 locations, to be performed off-line. For example, this is particularly useful when subscriber 10 is not at an access location 12, has no internet access and is looking for a log-on access point managed by provider 12.

In another embodiment of the present invention, driver module 230 is used to supply an update all of the necessary drivers to operate GUI module 210 and service module 220.

In another embodiment of the present invention, service manager application 200 may implement configurable profiles including service provider 14 configurable profiles, wireless access provider 12 configurable profiles, and subscriber 10 configurable profiles.

Service provider 14 configurable profiles allow service provider 14 to specify blocked networks, preferred networks and authentication schemes to be used, etc. Similarly, wireless access provider 12 profiles include any realms (internal physical location notations) that need to be appended to user identity for the purpose of proxy. Other capabilities may include the authentication mechanism supported at a specific wireless access hotspot 12. Subscriber 10 configurable profile settings include VPN (Virtual Private Networks), application launch profiles, auto connection options, network-specific user credentials, etc.

GUI module 210 and service module 220 of service manager application 200 may also support an embedded HTML compatible display area that allows display of access provider 12 messages, location specific messages, pre-pay notifications from access provider 12, etc. For example, access provider 2 may send periodic service notifications to all subscribers 10. These messages are captured by service manager 200 and displayed in a notification area.

In addition, location-specific messages may be delivered to subscriber 10 as well. For example, the location directory may contain pointers or advertisement to local links that correspond to specific locations. As noted above location information is stored in gateway 100 in partner module 112. As such, session log-ons from subscribers 10 include the location of such sessions. Access providers 12 or service providers 14 may have affiliates or other advertisers which may be pushed to subscriber 10 while in session, either on a web page or through GUI module 210, where such advertisements can be better targeted so that only local or otherwise geographically relevant advertisers are displayed to subscriber 10.

Other services handled by service manager 200 may include but are not limited to assisting in generating network performance and usage statistics, SMS management and conflicting application detection (on the equipment of subscriber 10).

In addition to the above features added by service manager application 200, as noted previously, service manager module 200 is able to provide additional tracking data to gateway 100 so that data collection and storage module 110 and mediation module 116 may generate even more detailed reports regarding the usage of subscribers 10 on the networks provide by access providers 12 and service providers 14.

For example, table 2 below shows additional data fields collected and sent from service manager application 200 to data collection and storage module 110 in gateway 100. Some of the fields may be redundant with TABLE 1 (info directly collected by gateway 100) but may be more accurate. Other fields are simply only obtainable from service manager application 200.

TABLE 2

| | |
|---|---|
| User Realm | Realm used to authenticate this user |
| User Id | User Id (Name, Phone Number or IMSI) of session |
| | user |
| Device Id | Device Id (typically the MAC address) of the client |
| Start Time | Start time of the session |
| End Time | End time of the session |
| Gateway Id | ID of Tatara Gateway |
| Gateway Session Id | The Session Id given to a session by the Tatara |
| | Gateway |
| Type | CTDR Type, FULL or FAILED |
| IMSI | IMSI of session user |
| Bytes In | Bytes transferred in during session |
| Bytes Out | Bytes transferred out during session |
| SSID | Network name of the wireless network NAS |
| Certificate Id | NAS certificate Id |
| NAS Id | Location NAS Id |
| Location Id | Id of this location |
| Client Version | Version of the software running on the client |
| Client Serial | Serial number of the client |
| Link Speed | Connection speed between the client and the access |
| | point |
| Error | Connection error |
| Packets In | Packets transferred in during session |
| Packets Out | Packets transferred out during session |
| Session Duration | Duration of the current session |
| Signal Strength | Signal strength between the client and the access |
| | point |
| Link In Errors | Errors on data transfers to the client |
| Link Out Errors | Errors on data transfers from the client |
| Failed Logins | Number of failed login attempts |

This data for example can be used in the instance of larger geographically diverse access providers 12. For example, if a large access provider 12 maintains multiple geographically diverse locations, some using different service providers 14. By having this additional information, access provider is able to obtain diverse and complete system wide usage information about subscriber 10 sessions, even where sessions are managed by disparate service providers 14.

Additional features of service manager application 200, that may be provided to subscriber 10 via the above described arrangement may also include auto-discovery of Wi-FI/Wi-MAX authentication method used by the network equipment of access provider 12; Auto-discovery of Wi-FI/Wi-MAX access provider 12 networks, location-specific branding by access provider 12 of GUI module 210, security status display of the session.

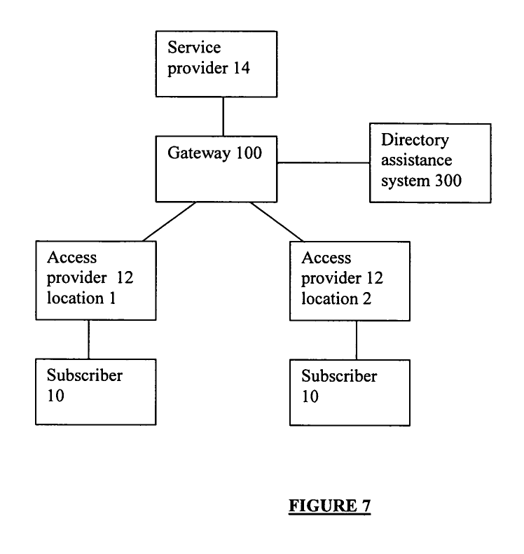

In another embodiment of the present invention, gateway 100 may be implemented as a node in a traditional Enhanced Directory Assistance system 300 as shown in FIG. 7. In such an arrangement, regardless of the set-up between gateway 100 and the network of service provider 14, gateway 100 is further included as a node in a directory assistance network 300.

In such an arrangement, a subscriber 10 who logs-on to a wireless network provided by access provider 12 would further be coupled to directory assistance system 300, having additional access to all of the attending services.

It is contemplated that in accessing gateway 100 directly (without service manager application 200) an additional link or DA button may be added to the web pages or web frame that allows subscriber 10 to access the DA. In the case of using service manager application 200 a DA button may simply be added via GUI interface module 210.

In either case, a link to DA system 300 may advantageously provide a number of additional services to subscriber 10. For example, subscriber 10 may simply activate the link to receive traditional directory assistance. The assistance may be provided by text (SMS, IM, live chat, HTTP, WAP, etc. . . . ) or may be done by voice through a digital or soft connection supported through the wireless session.

Another use of the DA button would be to seek additional information about some aspect of the web page being viewed via gateway 100. Because gateway 100 is a network in DA network 300, the customer service representative or computer agent would have some passive knowledge of the page being viewed by subscriber 10. In such an instance, subscriber 10 may press the link to DA system 300 and request additional information about some aspect on the web page being viewed, such as a request for a telephone number of a commercial institution that has a display on the page. As with regular directory assistance, system 300 may provide not only telephone numbers to the desired commercial institution, but may also provide other services such as connectivity options, additional data (hours, location, maps) and possibly reservation or ticket purchasing services if available.

Another feature may be that DA platform 300 can include branded audio messages (advertisements and cross-promotions) as either opening or closing prompts that relate to access provider 12, other paid advertisers from DA system 300, and/or local advertisements related to the location of subscriber 10. The location of subscriber 10 is easily derived from the session information being managed by system 100

It is understood that all of the possible features of directory assistance that may be employed are too numerous to recount individually. Any DA system 300 services provided to subscriber 10 via gateway 100 and a link provided therethrough, is within the contemplation of the present invention.

Turning now to the operation of the present invention, the following is a description of a subscriber 10 session via gateway 100 and service manager 200 (if applicable)

It is understood that, prior to subscribers 10 utilizing gateway 100, wireless access providers 12 and service providers 14 may employ typical set-up procedures to supply the necessary information to gateway 100 (partner module 112) including but not limited to connectivity protocols, security settings, equipment addresses and protocols, IP addresses, billing protocols, records and diagnostic formats, physical geographic location information, access provider 12 and service provider 14 contact information (telephone and address).

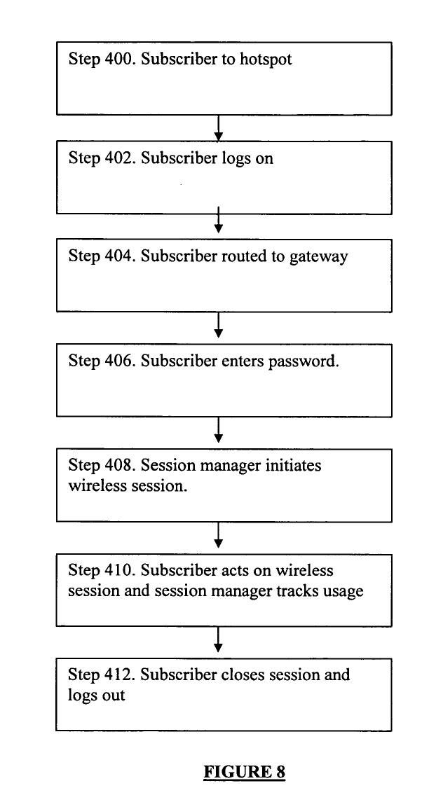

Assuming such set up is completed, a typical subscriber 10 information is conducted as shown in the accompanying flow chart FIG. 8. In a first step 400, subscriber 10 comes to a hotspot provided by access provider 12. Next, at step 402, subscriber 10 initiates a log-on session with the hotspot router or network equipment. At step 404, because of the arrangement between access provider 12 (and/or possibly service provider 14) the session is immediately routed to gateway 100.

At step 406, authentication module 108 of gateway 100 prompts subscriber 10 for a user ID and password. If they are prior subscribers 10 then they simply enter the information as prompted. If they are new subscribers to the network provided by access provider 12 then they need to set up a new account in the manner proscribed by access provider 12.

After the account is set up and log-in is verified, at step 408, session management module 104 begins the session through internet/wireless service provider 14 and data collection and storage module begins recording the information under the session ID set by session management module 104. At step 410, subscriber 10 acts freely on the wireless internet connection, taking advantage of any of the above described enhanced services offered via the present invention. Finally, at step 412, subscriber 10 logs-out and the session is closed by session management module 104 and the final session information is recorded.

Regarding the installation of service manager application 200, this may be installed (via plug-in) on the accessing device of subscriber 10 as a sub-routine between any number of steps outlined above for a gateway 100 enabled session. Any of the features or routines described above, enabled by service managing application 200 may also be implemented during session step (410) or at log-in (408) or log-off (412) as appropriate for the particular feature.

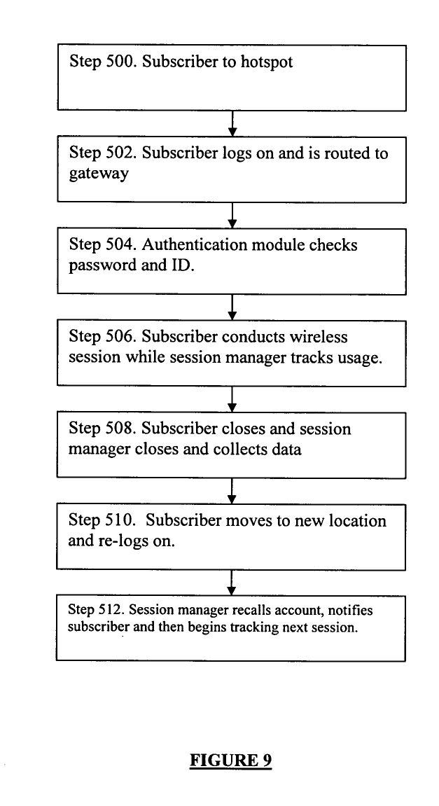

In another embodiment of the present invention, as illustrated in FIG. 9, a complex session flow include multiple log-ons to the same account, such as a pre-paid or other multi-use account.

At step 500, subscriber 10 enters a wireless access provider 12 location and initiates an account setup. Next, at step 502, subscriber 10 begins a wireless access session and is routed to gateway 100. At step 504, gateway 100 routs the session to authentication module 108. Once, authenticated, at step 506, session manager 104 handles the session flow and directs subscriber 10 to wireless service provider 14.

Once, subscriber 10 decides to log-off, at step 508, session manager 104 closes the session and records all of the relevant data to data collection and storage module 110.

At some later time or other location, at step 510, the same subscriber 10 re-initiates a session under the same account information. At step 512, session manager 104, recalls the account information from data collection and storage module 110, notifies subscriber 10 of the remaining time/amount left on the account, and sends the session through to service provider 14. These steps are repeated until the account is closed or runs out of funds.

As noted above, such account management is simplified from the perspective of access providers 12, as all account/session management is handled by a single (cluster) of gateways 100.

In one embodiment of the present invention, as described in more detail above, the present invention, via gateway 100, and with potential supplemental information from service management application 200, may provide real-time analysis to service provider 14 and access provider 12, as well as integrated billing and usage reports.

As noted above in both tables 1 and 2, gateway 100 maintains detailed records of wireless access which is aggregated across many locations of wireless access provider 12. This allows mediation module 116 and billing module 114 to generate and send location and venue specific details regarding subscriber 10 usage.

The usage information is important because it allows access providers to not only determine the effectiveness and marketability of their product to their customers (subscribers 10), but is also allows them greater leverage with their advertising partners where they can show specific geographically located usage (page views, etc. . . . ). Likewise, access providers 12 provided with such uniform and detailed information from data collection and storage module 110 may be able to audit their existing contracts with the service providers 14 and advertisers to ensure that their subscriber 10 usages is appropriate relative to their contracts.

The enhanced records further assist both service providers 14 and access providers 12 in auditing billing such that the detailed records may be used to audit existing billing contracts, and manage future service contracts. Such a feature is particularly advantageous in the context of the present invention where complex (pre-paid/multi-use) session bills are aggregated even where subscribers 10 utilize multiple access provider 12 locations.

Furthermore, as discussed above, these records for access provider 12 are comprehensive across their entire wireless access network. This is particularly advantageous for larger access providers 12 where certain locations in one geographic are use a first service provider 14 and other locations in other geographic areas use a second service provider 14.

In one embodiment of the present invention, mediation module 116 can pre-format billing information into a format compatible with the pre-existing billing formats used by each of various access providers 12 and each of service providers 14. This is further facilitated in the case of service provider 14 where gateway 100 is integrated directly into the network of service provider 14.

In addition to the added record keeping and billing advantages, mediation module 116, coupled to access providers 12 and service providers 14, is able to provider real-time access to the data in data collection and storage module 110 as provided from session manager 104. Such a feature is particularly useful for larger access providers 12 when a real-time analysis of subscriber 10 usage can provide valuable information. For example, certain times of day or during special events, may sharply increase usage on a particular network of an access provider 12. By monitoring and tracking this usage, access provider may better tailor their advertising packages.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1) A system for managing wireless internet access, said system comprising:
an interface for receiving incoming requests for wireless internet access from a plurality of subscribers, said subscribers submitting requests from a wireless access provider having a plurality of geographic locations at least one request coming from one location and at least a second request coming from a different location;
an authentication module for authenticating account information from said subscriber;
a session manager for monitoring each of said wireless internet access sessions of each of said subscribers;
a data collection and storage module for storing said session information; and
a mediation module for supplying usage reports to said wireless access provider based on said session information from each of said subscribers at each of said plurality of locations.

2) The system as claimed in claim 1, further comprising a billing module configured to aggregate all of said wireless access sessions of said subscribers from said geographic locations for delivery to said access provider.

3) The system as claimed in claim 1, further comprising a partner data module, configured to store the physical geographic location of each location maintained by said access provider.

4) The system as claimed in claim 3, wherein a subscriber in wireless internet session through said system via said access provider, may access the geographic location of other locations for wireless internet access offered by said access provider.

5) The system as claimed in claim 3, wherein said system utilizes data derived from subscriber sessions to automatically update the geographic locations for wireless internet access provided by said access provider.

6) The system as claimed in claim 3, wherein said system is configured to utilize said geographic location data to provide location specific advertising to said subscriber.

7) A system for managing wireless internet access, said system comprising:
an interface for receiving incoming requests for wireless internet access from a plurality of subscribers, said subscribers submitting requests from a wireless access provider having a plurality of geographic locations at least one request coming from one location and at least a second request coming from a different location;
an authentication module for authenticating account information from said subscriber;
a session manager for monitoring each of said wireless internet access sessions of each of said subscribers;
a data collection and storage module for storing information from said session
a service manager application, said service manager application configured to reside in accessing devices of said subscribers, wherein said service manager application is configured to track additional usage details of said session information for reporting to said session manager and said data collection and storage module; and
a mediation module for supplying usage reports to said wireless access provider based on said session information from each of said subscribers at each of said plurality of locations.

8) The system as claimed in claim 7, further comprising a partner data module, configured to store the physical geographic location of each location maintained by said access provider.

9) The system as claimed in claim 8, wherein a subscriber in wireless internet session through said system via said access provider, may access the geographic location of other locations for wireless internet access offered by said access provider.

10) The system as claimed in claim 9, wherein said service manager application is configured to allow said subscriber to view said other geographic locations while offline.

11) The system as claimed in claim 9, wherein said system utilizes data derived from subscriber sessions to automatically update the geographic locations for wireless internet access provided by said access provider.

12) The system as claimed in claim 7, wherein said service manager application maintains a graphical user interface for providing a branded skin related to said access provider.

13) The system as claimed in claim 7, wherein said service manager application maintains a service module for facilitating access provider applications to said subscriber.

14) A system for managing wireless internet access, said system comprising:
an interface for receiving incoming requests for wireless internet access from a plurality of subscribers, said subscribers submitting requests from a wireless access provider having a plurality of geographic locations;
an authentication module for authenticating account information from said subscriber;
a session manager for monitoring each of said wireless internet access sessions of each of said subscribers; and
a data collection and storage module for storing said session information; wherein said system includes a link to a directory assistance system operator, such that said subscriber can activate link and be connected directly to a directory assistance operator.

15) The system as claimed in claim 14, wherein said directory assistance operator has access to the page being viewed so that information related to the page may be used during a directory assistance session.

16) The system as claimed in claim 14, further comprising a partner data module, configured to store the physical geographic location of each location maintained by said access provider.

17) The system as claimed in claim 16, wherein said directory assistance system knows the physical location of said subscriber.

18) The system as claimed in claim 14, wherein said directory assistance system can operate in either one of a text or voice format.

19) The system as claimed in claim 14, wherein said directory assistance system may initiate calls to desired parties for said subscriber.

20) The system as claimed in claim 14, wherein said directory assistance system may provide enhanced reservations, mapping and directions services.

21) The system as claimed in claim 16, wherein said directory assistance system may incorporate closing prompts into said directory assistance sessions based on the geographic location of said subscriber.

22) A system for managing wireless internet access, said system comprising:
an interface for receiving incoming requests for wireless internet access from a plurality of subscribers, said subscribers submitting requests from a wireless access provider having a plurality of geographic locations at least one request coming from one location and at least a second request coming from a different location;
an authentication module for authenticating account information from said subscriber;
a session manager for monitoring each of said wireless internet access sessions of each of said subscribers;
a data collection and storage module for storing said session information;
an interface for communicating wireless internet sessions with a plurality of wireless internet service provides for each of said geographic locations of said access providers, wherein at least one service provider services at least one geographic location of at least one of said access providers and at least one other service provider services at least one other geographic location of said at least one of said access providers; and
a mediation module for supplying usage reports to said wireless access provider based on said session information from each of said subscribers at each of said plurality of locations.

23. The system as claimed in claim 22, further comprising a partner data module, configured to store the physical geographic location of each location maintained by said access provider and the corresponding service provider utilized by each.

24. The system as claimed in claim 22, further comprising a billing database configured to aggregate all wireless internet access billing information for all geographic locations and service providers into a complete billing report.

25. The system as claimed in claim 22, wherein said mediation module report on wireless access sessions from all geographic locations maintained by said access provider are provided as a complete report.

26) A method for managing wireless internet access, said method comprising the steps of:
receiving at an interface incoming requests for wireless internet access from a plurality of subscribers, said subscribers submitting requests from a wireless access provider having a plurality of geographic locations at least one request coming from one location and at least a second request coming from a different location;
authenticating account information from said subscriber;
monitoring each of said wireless internet access sessions of each of said subscribers;
collecting and storing said session information; and
supplying usage reports to said wireless access provider based on said session information from each of said subscribers at each of said plurality of locations.

27) A method for managing wireless internet access, said method comprising the steps of:
receiving at an interface incoming requests for wireless internet access from a plurality of subscribers, said subscribers submitting requests from a wireless access provider having a plurality of geographic locations at least one request coming from one location and at least a second request coming from a different location;
authenticating account information from said subscriber;
monitoring each of said wireless internet access sessions of each of said subscribers;
collecting and storing said session information;
supplying a service manager application configured to reside in accessing devices of said subscribers, wherein said service manager application is configured to track additional usage details of said session information for reporting to said session manager and said data collection and storage module; and
supplying usage reports to said wireless access provider based on said session information from each of said subscribers at each of said plurality of locations.

28) A method for managing wireless internet access, said method comprising the steps of:
receiving incoming requests for wireless internet access from a plurality of subscribers, said subscribers submitting requests from a wireless access provider having a plurality of geographic locations;
authenticating account information from said subscriber;
monitoring each of said wireless internet access sessions of each of said subscribers; and
collecting and storing said session information; wherein said system includes a link to a directory assistance system operator, such that said subscriber can activate link and be connected directly to a directory assistance operator.

29) A method for managing wireless internet access, said method comprising the steps of:
receiving incoming requests for wireless internet access from a plurality of subscribers, said subscribers submitting requests from a wireless access provider having a plurality of geographic locations at least one request coming from one location and at least a second request coming from a different location;
authenticating account information from said subscriber;
monitoring each of said wireless internet access sessions of each of said subscribers;
collecting and storing said session information;
communicating wireless internet sessions via an interface with a plurality of wireless internet service provides for each of said geographic locations of said access providers, wherein at least one service provider services at least one geographic location of at least one of said access providers and at least one other service provider services at least one other geographic location of said at least one of said access providers; and
supplying usage reports to said wireless access provider based on said session information from each of said subscribers at each of said plurality of locations.
